(19) United States
(12) Patent Application Publication
(10) Pub. No.: US 2025/0326230 A1
(43) Pub. Date: Oct. 23, 2025

(54) INK CONTAINER AND CLEANING METHOD OF INK CONTAINER

(71) Applicant: CANON KABUSHIKI KAISHA, Tokyo (JP)

(72) Inventor: NAOYA TSUKAMOTO, Kanagawa (JP)

(21) Appl. No.: 19/185,872

(22) Filed: Apr. 22, 2025

(30) Foreign Application Priority Data
Apr. 23, 2024 (JP) 2024-069687

(51) Int. Cl. B41J 2/175; B41J 2/17; B41J 29/17

(52) U.S. Cl. CPC B41J 2/17553; B41J 2/1707; B41J 29/17

(57) ABSTRACT

An ink container includes an ink containing portion configured to contain ink therein, and a first opening portion configured to allow an inside and an outside of the ink containing portion to communicate with each other, in which a corner portion inside the ink containing portion is formed to have a round shape of a ridge curve line of a predetermined radius. The ink container achieves both the adaptation to ink of arbitrary properties and the reduction of environmental load, and may contribute to realize a sustainable society such as a decarbonized/recycling society.

### BACKGROUND

### Field

The present disclosure relates to an ink container and a cleaning method thereof.

### Description of the Related Art

An ink jet printer is an output device that forms a character and an image by discharging ink in fine droplets from an ink jet printing head. In recent years, the ink jet printer has been utilized for home use and as an office device and has also become common for industrial use. There is a container used by forming a bag from a lamination film and the like, which is the container for the ink as a printing material for the ink jet printer.

Japanese Patent Laid-Open No. 2006-062282 proposes improvement of washability of an ink container by separating an ink supply member from the ink container for reuse and widening an opening of an ink containing bag as an ink containing portion. Additionally, Japanese Patent Laid-Open No. 2023-100579 proposes an ink container with improved recyclability obtained by cutting a part of an ink containing bag and welding the ink containing bag again after cleaning.

Incidentally, in recent years, there has been demanded product development to reduce load on the global environment. As for the ink container, recycling and reusing may be applied as a conventional method of reducing environmental load. Additionally, in recent years, using of biodegradable plastics as a material used for the ink container may be applied as another method of reducing environmental load. This makes it possible to landfill and discard a used ink container without putting load on the environment by using reductive plastics.

Contrary to the demand of the reduction of environmental load as described above, the ink jet printer has been demanded to adapt to ink of arbitrary properties. For this reason, in order to achieve both the reduction of environmental load and the adaptation to ink of arbitrary properties, it has been demanded to clean an ink containing portion after use with no remaining ink regardless of the properties of the ink.

However, in Japanese Patent Laid-Open No. 2006-062282, although the washability is improved by widening the opening of the ink containing bag, the ink remains in some cases in a corner portion of the ink containing portion depending on the ink properties of the ink used. Additionally, in Japanese Patent Laid-Open No. 2023-100579, since it is possible to clean with flowing water from two openings, there is less concern that the ink remains; however, it is still difficult to achieve complete reuse since it requires breaking an ink bag, and therefore there is a problem in the perspective of reducing environmental load.

### SUMMARY

Therefore, in light of the issues described above, the present disclosure advantageously provides an ink container that achieves both the adaptation to ink of arbitrary properties and the reduction of environmental load.

According to some embodiments, an ink container includes an ink containing portion configured to contain ink therein, and a first opening portion configured to allow an inside and an outside of the ink containing portion to communicate with each other, in which a corner portion inside the ink containing portion is formed to have a round shape of a ridge curve line of a predetermined radius.

Further features of the present disclosure will become apparent from the following description of exemplary embodiments with reference to the attached drawings.

### BRIEF DESCRIPTION OF THE DRAWINGS

FIG. 1 is a schematic diagram illustrating an ink container in a first embodiment.

FIG. 2 is a schematic diagram illustrating the ink container in the first embodiment.

FIG. 3 is a schematic diagram illustrating the ink container in the first embodiment.

FIGS. 4A and 4B are schematic diagrams illustrating the ink container in a second embodiment.

FIGS. 5A and 5B are schematic diagrams illustrating the ink container in the second embodiment.

FIG. 6 is a schematic diagram illustrating the ink container in a third embodiment.

FIG. 7 is a schematic diagram illustrating the ink container in the third embodiment.

FIG. 8 is a schematic diagram illustrating the ink container in a fourth embodiment.

FIG. 9 is a schematic diagram illustrating the ink container in the fourth embodiment.

FIG. 10 is a schematic diagram illustrating the ink container in the fourth embodiment.

### DESCRIPTION OF THE EMBODIMENTS

Various exemplary embodiments, features, and aspects of the present disclosure are described below in detail with reference to the appended drawings. Note that, the following embodiments are not intended to limit the matters of the present disclosure, and not all the combinations of the characteristics described in the present embodiments are necessarily used for the means for solving the problems of the present disclosure. Note that, the same constituents are provided with the same reference numerals in principle.

In recent years, in response to concern about resource depletion, a marine plastic problem that causes pollution of ocean with discarded plastics, and the like, the importance of cyclic use of resources has been increased worldwide. In order to achieve efficient utilization of limited resources and reduction of waste, saving of resources by downsizing and weight reduction of a product and reusing and recycling of a used product have been proceeding. A technique described in the present disclosure that is proposed under the above-described circumstances may contribute to realize a sustainable society such as a decarbonized/recycling society.

### First Embodiment

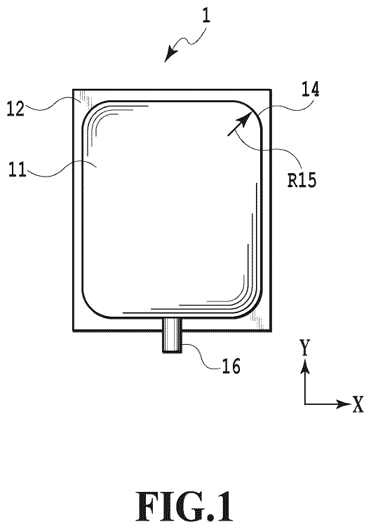

A first embodiment of the present disclosure is described below with reference to FIGS. 1 to 3, which are schematic diagrams (front views) illustrating an ink container 1 of the first embodiment. The ink container 1 is formed by welding lamination films that have flexibility and include a layer having ink resistance and gas barrier property. In a case where the lamination films are welded, an ink containing bag opening portion 16 is formed by welding outer periphery edges of the lamination films while sandwiching a spout member. The ink container of the present embodiment is in the form of a spout pouch, and the ink containing bag opening portion 16 allows the inside and the outside of an ink containing portion 11 to communicate with each other. The ink containing bag opening portion 16 is connected to a filling port in a case of filling the bag-shaped ink containing portion 11 with the ink or connected to an ink jet printer so as to be used as a connection port in a case of supplying the printer with the ink. A shape of a welding portion 12 of the film outer periphery edge is determined by a welding tool, and shapes of the ink containing portion 11 and an ink containing portion corner portion 14 are determined accordingly. The ink containing portion 11 is formed on an inner side the welding portion 12 by providing the welding portion 12 on an outer side of the ink container 1. In the ink containing portion corner portion 14, a radius R15 of the ink containing portion corner portion is formed properly according to the ink properties. Note that, hereinafter, a radius of a round portion such as a corner portion (a curve line) is expressed as “R” (abbreviation of Radius). Additionally, as illustrated in FIG. 1, a horizontal axis is referred to as an X axis, while a vertical axis is referred to as a Y axis, and this coordinate axis is similarly used in other drawings as well.

The ink container of the present disclosure is recycled, reused, or discarded in a form that has no environmental load by cleaning the ink containing portion 11 after the ink is used and washing away the remaining ink. In this process, the washability of the ink containing portion 11 is an issue. That is, in a case where no R is formed in the ink containing portion corner portion, even if the ink containing portion is tried to be cleaned by a method such as agitation with water put in the ink containing portion 11, the ink containing portion corner portion becomes a stagnation point (a place where a cleaning liquid does not move), and the ink may remain because of insufficient cleaning. To deal with such an issue, the present embodiment focuses on this ink containing portion corner portion, and the stagnation of the flow of the cleaning liquid is reduced to obtain a cleaning effect.

How much the ink is attached to an inner wall of the ink containing portion 11 that may be cleaned is usually determined based on a relationship between a surface tension of the ink and a surface tension (surface free energy) of the ink containing portion inner wall. In this case, as the surface tension of the ink containing portion inner wall is relatively greater than the surface tension of the ink, the liquid is more likely to be wet. On the other hand, as a viscosity of the ink is higher, an effect of the surface tension is reduced, and the ink is likely to be adhered to the ink containing portion inner wall regardless of the surface tensions of the ink and the ink containing portion inner wall. Additionally, as a temperature is increased, the surface tension and the viscosity are both likely to be decreased, and in this case, the ink is likely to be adhered to the ink containing portion inner wall because of an effect of the reduction of the surface tension. Therefore, a predetermined radius for a ridge curve line of the ink containing portion corner portion has to be derived according to the surface tension of the ink.

In the present embodiment, as a result of earnest consideration, the ink containing portion of the lamination film using polyethylene as an ink-resistant layer put in contact with the ink is formed such that at least a part of the inner wall is a curved surface. Specifically, according to the ink with the surface tension of a value within a range of 20 milli-Newton per meter [mN/m] or greater and 45 [mN/m] or smaller, the curved surface including the ridge curve line of the radius R that is a radius of a value within a range of 5 millimeter [mm] or greater and 10 [mm] or smaller is formed in the ink containing portion corner portion. With this shape, it is possible to improve the washability of the ink containing portion corner portion more than a case where no R is formed in the ink containing portion corner portion or a case where there is R having a radius of around 1 to 2 [mm] in the corner portion that is generated unintentionally as a result of a manufacturing process.

Note that, a material of the ink-resistant layer of the ink containing portion that is put in contact with the ink is not limited, and it is possible to change the material according to the ink container and an ink type as desired. For example, it is also possible to discard the cleaned ink container in a form that has a lower environmental load by using the ink containing portion functioning as the ink containing bag that is made of biodegradable plastics. Additionally, the values of the ink surface tension and the ink containing portion corner portion radius are not limited to the above-described embodiment, and it is possible to change the values as desired as long as the washability is secured.

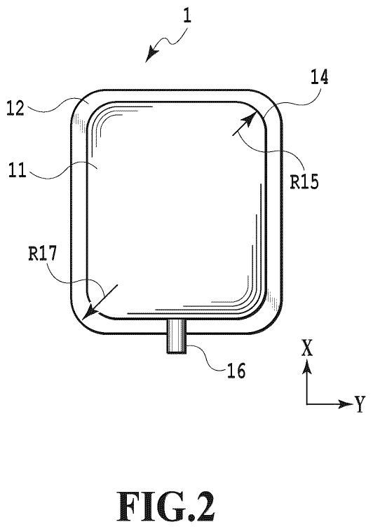

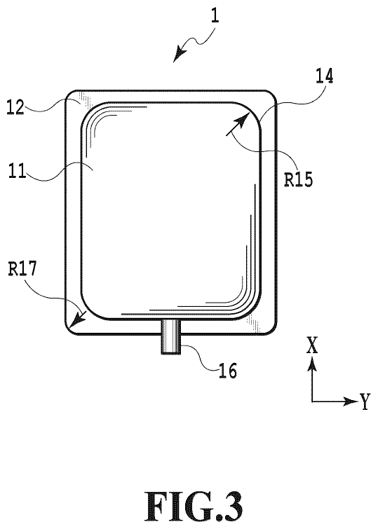

Moreover, in order to prevent a cut wound by the ink container, a welding portion outer edge corner portion may be rounded. As illustrated in FIG. 2, in a case where a radius R17 of the welding portion outer edge corner portion of the ink container 1 is greater than the radius R15 of the ink containing portion corner portion, the rounded welding portion outer edge corner portion makes it possible to avoid contact of the welding portion outer edge corner portion to another part. Furthermore, as illustrated in FIG. 3, in a case where the radius R17 of the welding portion outer edge corner portion of the ink container 1 is smaller than the radius R15 of the ink containing portion corner portion, it is possible to improve a welding margin because a welding seam of an ink container outer edge is increased in addition to a similar effect as that in FIG. 2.

As above, according to the present embodiment, the implementation of high washability of the ink container makes it possible to provide an ink container and a cleaning method thereof that achieve both the adaptation to ink of arbitrary properties and the reduction of environmental load.

### Second Embodiment

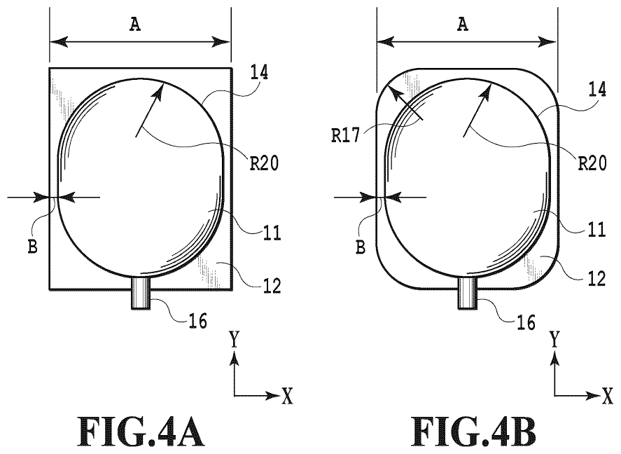

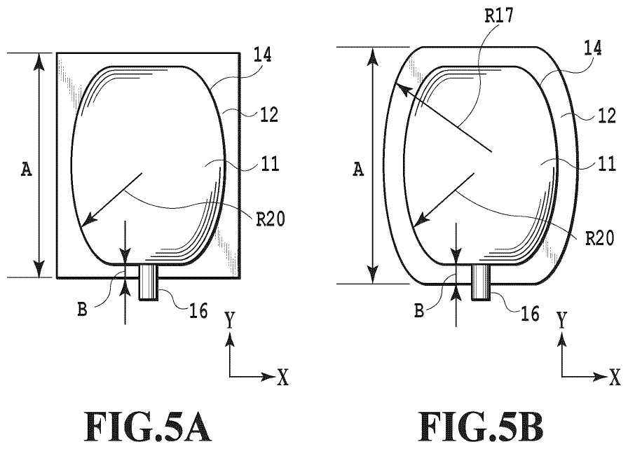

A second embodiment of the present disclosure is described below with reference to FIGS. 4A, 4B, 5A, and 5B. FIGS. 4A and 5A are schematic diagrams illustrating the ink container in the second embodiment. In the present embodiment, the ridge of the ink containing portion 11 is formed of a curve line having a greater radius than that in the first embodiment. Therefore, in the present embodiment, a ratio of the ridge curve line forming the ink containing portion is greater than that in the first embodiment.

In the present embodiment, the above-described shape reduces a surface area of the ink containing portion 11 and reduces an area of the containing portion inner wall put in contact with the ink. A radius R20 of the ink containing portion ridge curve line is changed in proportion to a dimension of the ink container. As a result of earnest consideration, the maximum value of the radius R20 of the ink containing portion ridge curve line is defined by a following expression (1):

$$R 2 {0}_{max} = ( A - 2 B ) / 0.347 . \qquad expression ( 1 )$$

R20ₘₐₓ is the maximum value of the radius R20 of the ink containing portion ridge curve line.
A: a length of an ink container outer edge side (the length of the ink container outer edge side that does not cross a virtual extension line of the ink containing portion ridge curve line)
B: a welding portion length on the virtual extension line of the ink containing portion ridge curve line (the minimum length of the welding portion length in the same direction as that of A)

Here, A is the length of the ink container outer edge side that does not cross the virtual extension line of the ink containing portion ridge curve line, and B is the welding portion length outside the ink containing bag that is on the virtual extension line of the ink containing portion ridge curve line (a distance between the ink container outer edge side and an ink containing bag outer edge side). FIGS. 4A and 4B illustrate a case where a transverse side of the ink container is A, and FIGS. 5A and 5B illustrate a case where a longitudinal side of the ink container is A, respectively. Note that, as with the first embodiment, as illustrated in FIG. 4B, the ink container outer edge may be formed of the curve line of the radius R17 smaller than the radius R20 of the ink containing portion ridge curve line. Additionally, as illustrated in FIG. 5B, the ink container outer edge may be formed of the curve line of the radius R17 greater than the radius R20 of the ink containing portion ridge curve line.

As above, according to the present embodiment, in addition to the obtainment of a similar effect as that of the first embodiment, it is possible to improve the cleaning efficiency by reducing an ink attachment area in the ink containing portion. Additionally, it is possible to improve flowability of the cleaning liquid in the ink containing portion.

### Third Embodiment

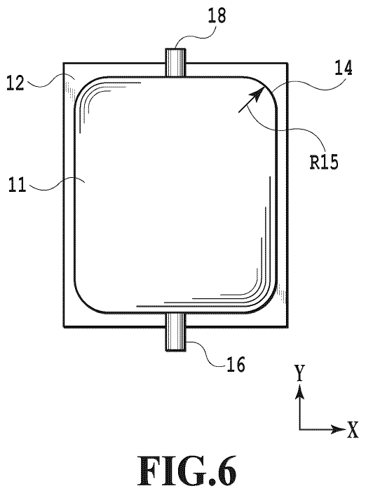

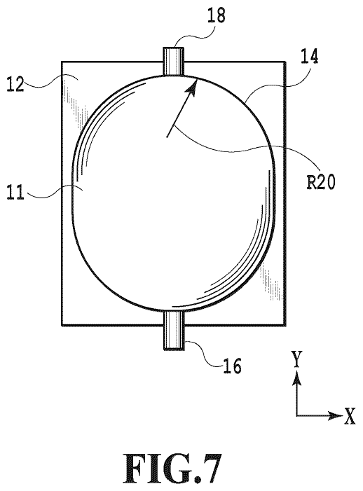

A third embodiment of the present disclosure is described below with reference to FIGS. 6 and 7, which are schematic diagrams illustrating the ink container in the third embodiment. Unlike the first embodiment and the second embodiment, in the present embodiment, a second ink containing bag opening portion 18 is formed in a position on the opposite side of the ink containing portion 11 from the ink containing bag opening portion 16. Note that, in the following embodiment, the ink containing bag opening portion 16 is also referred to as a first ink containing bag opening portion 16.

It is possible to continuously flow the cleaning liquid in the ink containing portion by utilizing two opening portions, that is, the first ink containing bag opening portion 16 and the second ink containing bag opening portion 18, to perform injecting and ejecting of the cleaning liquid (for example, water) concurrently. In other words, a cleaning method of the ink container can perform injection by injecting the cleaning liquid from one of the first opening portion 16 and the second opening portion 18 and ejecting the cleaning liquid from the other one of the first opening portion 16 and the second opening portion 18 that does not perform the injection. That is, the cleaning liquid is injected from the first ink containing bag opening portion 16 while the injected cleaning liquid is ejected from the second ink containing bag opening portion 18, or the cleaning liquid is injected from the second ink containing bag opening portion 18 while the injected cleaning liquid is ejected from the first ink containing bag opening portion 16. Note that, it is possible to utilize the second ink containing bag opening portion 18 also as a filling port in filling with the ink and an air communication port in addition to the cleaning of the ink containing portion. Note that, although it is not described above, the present embodiment may be applied to the ink container 1 illustrated in FIGS. 4B, 5A, and 5B, that is, the second ink containing bag opening portion 18 may be formed in a position on the opposite side of the ink containing portion 11 from the first ink containing bag opening portion 16.

As above, according to the present embodiment, in addition to the obtainment of a similar effect as that in the first embodiment and the second embodiment, it is possible to further improve the cleaning efficiency for the ink containing portion.

### Fourth Embodiment

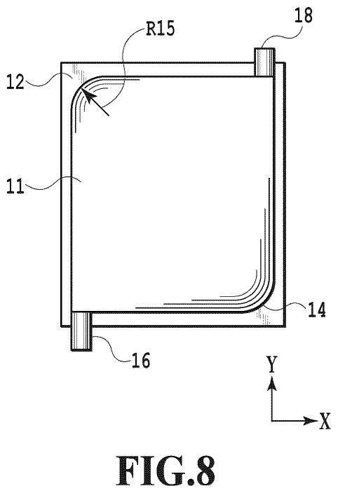

A fourth embodiment of the present disclosure is described with reference to FIGS. 8, 9, and 10, which are schematic diagrams illustrating the ink container in the fourth embodiment. Unlike the third embodiment, in the present embodiment, the first ink containing bag opening portion 16 and the second ink containing bag opening portion 18 are formed in different corner portions in the ink containing portion 11, respectively. With the ink containing bag opening portion being provided in the ink containing portion corner portion as described above, it is possible to reduce a portion provided with the R shape of the containing portion corner portion and to increase the inner volume of the ink containing portion.

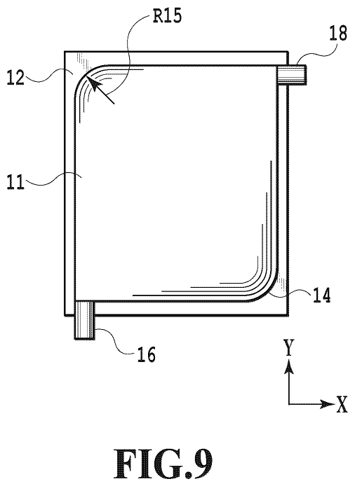

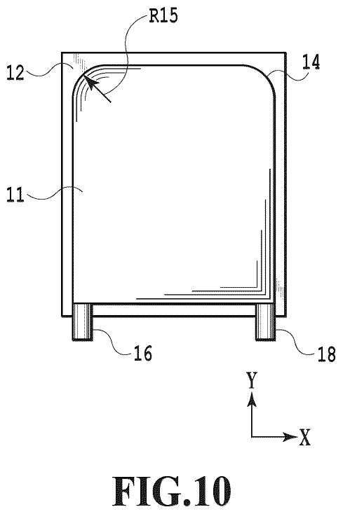

Additionally, in the third embodiment, the second ink containing bag opening portion 18 is formed in the position on the opposite side of the ink containing portion 11 from the first ink containing bag opening portion 16. That is, the first ink containing bag opening portion 16 is formed on a first side that is a straight line forming a rectangular of the ink container outer edge while the second ink containing bag opening portion 18 is formed on a second side (a straight line) that is an opposite side of the first side, and the positions of the two opening portions in the X direction are the same. In contrast, in the present embodiment, the opening portions are formed diagonally in the ink containing portion 11 in FIG. 8, the opening portions are formed on crossing sides of the outer edge of the ink containing portion 11 diagonally in the ink containing portion 11 in FIG. 9, and the opening portions are formed on the same one side (the same straight line) of the outer edge of the ink containing portion 11 in FIG. 10, respectively. The opening portions formed in various directions make it possible to improve a degree of freedom for designing on an ink jet printer side to which the ink container is attached.

As above, according to the present embodiment, in addition to the obtainment of a similar effect as that of the first to third embodiments, it is possible to improve the efficiency of containing the ink. Additionally, it is possible to improve a degree of freedom for designing a relative position between the first ink containing bag opening portion functioning as the ink supply unit that supplies the printing apparatus with the ink and the second ink containing bag opening portion functioning as the injection port into which the ink is injected and the air communication port.

### OTHER EMBODIMENTS

Note that, the techniques of the above-described first embodiment to fourth embodiment may be used in combination as desired.

According to the present disclosure, it is possible to provide an ink container that achieves both the adaptation to ink of arbitrary properties and the reduction of environmental load.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-069687, filed Apr. 23, 2024, which is hereby incorporated by reference wherein in its entirety.

What is claimed is:

1. An ink container comprising:
an ink containing portion configured to contain ink therein; and
a first opening portion configured to allow an inside and an outside of the ink containing portion to communicate with each other, wherein
a corner portion inside the ink containing portion is formed to have a round shape of a ridge curve line of a predetermined radius.

2. The ink container according to claim 1, further comprising:
a welding portion in which outer periphery edges of lamination films are welded, wherein
the ink containing portion is bag-shaped and is formed on an inner side of the welding portion.

3. The ink container according to claim 2, wherein
the predetermined radius is derived according to a surface tension of the ink.

4. The ink container according to claim 3, wherein
a first radius of the ridge curve line is a value within a range of 5 millimeter (mm) or greater and 10 mm or smaller, and
the surface tension of the ink is a value within a range of 20 milli-Newton per meter (mN/m) or greater and 45 mN/m or smaller.

5. The ink container according to claim 4, wherein
a maximum value of the first radius is expressed by the maximum value=(A−2B)/0.347, where A indicates a length of an outer edge side of the ink container, and B indicates a minimum length of the welding portion in a same direction of the length of the outer edge side of the ink container.

6. The ink container according to claim 5, further comprising:
a second opening portion configured to allow the inside and the outside of the ink containing portion to communicate with each other.

7. The ink container according to claim 6, wherein
the second opening portion is formed on an opposite side of the ink containing portion from the first opening portion.

8. The ink container according to claim 7, wherein
the first opening portion is formed in a first corner portion of the ink containing portion, and the second opening portion is formed in a second corner portion positioned diagonally to the first corner portion.

9. The ink container according to claim 8, wherein
the first opening portion is formed on a first side that is a straight line forming the ink containing portion, and
the second opening portion is formed on a second side that is a straight line forming the ink containing portion.

10. The ink container according to claim 9, wherein
the second side is an opposite side of the first side.

11. The ink container according to claim 9, wherein
the first side and the second side cross each other.

12. The ink container according to claim 8, wherein
the first opening portion and the second opening portion are formed on a first side that is a straight line forming the ink containing portion.

13. The ink container according to claim 4, wherein
the first radius is smaller than a second radius of a corner portion of an outer edge of the ink container.

14. The ink container according to claim 4, wherein
the first radius is greater than a second radius of a corner portion of an outer edge of the ink container.

15. The ink container according to claim 1, wherein
the ink containing portion has flexibility.

16. The ink container according to claim 1, wherein
the ink containing portion is made of plastic.

17. The ink container according to claim 1, wherein
the first opening portion is used as a connection port in a case where a printing apparatus is supplied with the ink from the ink containing portion.

18. A cleaning method of the ink container according to claim 6, comprising:
perform injection by injecting a cleaning liquid from one of the first opening portion and the second opening portion and ejecting the cleaning liquid from the other one of the first opening portion and the second opening portion that does not perform the injection.
